(19) United States
(12) Patent Application Publication
(10) Pub. No.: US 2025/0350927 A1
(43) Pub. Date: Nov. 13, 2025

(54) METHOD AND APPARATUS FOR SUPPORTING USER CONSENT MANAGEMENT IN WIRELESS COMMUNICATION SYSTEM

(71) Applicant: Samsung Electronics Co., Ltd., Suwon-si (KR)

(72) Inventors: Hyesung KIM, Suwon-si (KR); Jicheol LEE, Suwon-si (KR); Hongjin CHOI, Suwon-si (KR)

(21) Appl. No.: 19/205,200

(22) Filed: May 12, 2025

(30) Foreign Application Priority Data
May 13, 2024 (KR) 10-2024-0062528

(51) Int. Cl. H04W 8/22; H04W 8/20; H04W 76/20

(52) U.S. Cl. CPC H04W 8/22; H04W 8/20; H04W 76/20

(57) ABSTRACT

The disclosure relates to a 5G or 6G communication system for supporting a higher data transmission rate. A method performed by a first network entity in a wireless communication system is provided. The method includes receiving, from a network exposure function (NEF), a user equipment (UE) identifier (ID) request related to a first application function (AF), identifying user consent for the UE ID request, and transmitting, to the first AF through the NEF, a UE ID based on the user consent.

### CROSS-REFERENCE TO RELATED APPLICATION(S)

This application is based on and claims priority under 35 U.S.C. § 119 (a) of a Korean patent application number 10-2024-0062528, filed on May 13, 2024, in the Korean Intellectual Property Office, the disclosure of which is incorporated by reference herein in its entirety.

### BACKGROUND

### 1. Field

The disclosure relates to a method for collecting and managing user consent related to a service that is provided in a wireless communication system.

### 2. Description of Related Art

Fifth-generation (5G) mobile communication technologies define broad frequency bands such that high transmission rates and new services are possible, and can be implemented not only in “Sub 6GHz” bands such as 3.5 GHz, but also in “Above 6 GHz” bands referred to as millimeter wave (mmWave) including 28 GHZ and 39 GHz. In addition, it has been considered to implement sixth generation (6G) mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive multiple-input multiple-output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BandWidth Part (BWP), new channel coding methods such as a Low Density Parity Check (LDPC) code for large amount of data transmission and a polar code for highly reliable transmission of control information, layer 2 (L2) pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, new radio (NR) user equipment (UE) power saving, non-terrestrial network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, Integrated Access and Backhaul (IAB) for providing a node for network service area expansion by supporting a wireless backhaul link and an access link in an integrated manner, mobility enhancement including conditional handover and Dual Active Protocol Stack (DAPS) handover, and two-step random access for simplifying random access procedures (2-step random access channel (RACH) for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting Augmented Reality (AR), Virtual Reality (VR), Mixed Reality (MR) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and Artificial Intelligence (AI) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method for collecting and dynamically managing user consent to providing user-related information to an external application server or application function among services provided in a wireless communication system.

Another aspect of the disclosure is to provide an operation for managing the validity of user consent and preventing infringement on user-related information provided by a wireless communication system when user consent is withdrawn.

Additional aspects will be set forth in part in the description which follows and, in part, will be apparent from the description, or may be learned by practice of the presented embodiments.

In accordance with an aspect of the disclosure, a method performed by a first network entity in a wireless communication system is provided. The method includes receiving, from a network exposure function (NEF), a user equipment (UE)-related information request message, identifying user consent for the UE ID request, and transmitting, to the first AF through the NEF, a UE ID based on the user consent.

In accordance with another aspect of the disclosure, a method performed by a UE in a wireless communication system is provided. The method includes transmitting, to a unified data management (UDM), a user consent setting request message including user consent-related information, and receiving, from the UDM, a user consent setting response message, wherein user consent-related information is used to provide a UE identifier (ID) to a first application function (AF) having transmitted a UE ID request.

In accordance with another aspect of the disclosure, a first network entity in a wireless communication system is provided. The first network entity includes a transceiver, and at least one processor communicatively coupled to the transceiver and memory, communicatively coupled to the at least one processor, storing instructions executable by the at least one processor individually or in any combination to cause the UDM entity to receive, from a network exposure function (NEF), a user equipment (UE) identifier (ID) request related to a first application function (AF), identify user consent for the UE ID request and transmit, to the first AF through the NEF, a UE ID based on the user consent.

In accordance with another aspect of the disclosure, a UE in a wireless communication system is provided. The UE includes a transceiver, and at least one processor communicatively coupled to the transceiver and memory, communicatively coupled to the at least one processor, storing instructions executable by the at least one processor individually or in any combination to cause the UE to transmit, to a unified data management (UDM), a user consent setting request message including user consent-related information, and receive, from the UDM, a user consent setting response message, wherein the user consent-related information is used to provide UE identifier (ID) to a first application function (AF) having transmitted a UE ID request.

The disclosure quality enables assurance of integrated sensing/communication services provided in a wireless communication system.

It is possible to enhance user convenience by the method and device for dynamically managing user consent to providing user-related information in a wireless communication system proposed in the disclosure.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a view illustrating an example of a configuration of a wireless communication system, illustrating a configuration of a 5G system according to an embodiment of the disclosure;

FIG. 2 is a flowchart illustrating operations related to setting and withdrawing user consent when a UE provides user consent given/un-given information according to an embodiment of the disclosure;

FIG. 3 is a flowchart illustrating operations related to setting and withdrawing user consent when an AF provides user consent given/un-given information according to an embodiment of the disclosure;

FIG. 4 is a block diagram illustrating a configuration of a network entity according to an embodiment of the disclosure; and

FIG. 5 is a block diagram illustrating a configuration of a UE according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The terms referring to network entities or network functions and objects of a wireless communication system as used herein, the terms referring to messages, and the term referring to identification information are provided as an example for ease of description. Thus, the disclosure is not limited by the terms, and such terms may be replaced with other terms denoting objects with equivalent technical concept.

Although terms and names as defined in the 5G system standard are used herein for ease of description, embodiments of the disclosure are not limited thereto or thereby, and the same may apply likewise to wireless communication systems conforming to other standards or next-generation standards.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

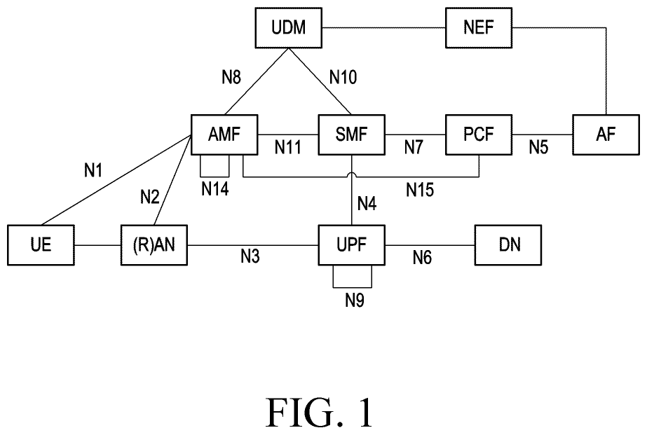

FIG. 1 illustrates a 5G system structure supporting an integrated sensing and communications service (hereinafter referred to as an ISAC service for convenience of description) according to an embodiment the disclosure.

A 5G system structure may include various network functions (NFs), some of which are illustrated in FIG. 1, such as an access and mobility management function (AMF), a session management function (SMF), a policy control function (PCF), unified data management (UDM), unified data repository (UDR), a data network (DN), or a local part of DN capable of local access to the data network, a user plane function (UPF), a (radio) access network ((R)AN), and a user equipment (UE).

Each NF supports the following functions.
AMF provides functions for per-UE access and mobility management and may connect basically to one AMF per UE.
DN means, e.g., an operator service, Internet access, or a third party service. The DN transmits a downlink protocol data unit (PDU) to the UPF or receives a PDU transmitted from UE from UPF. Local part of DN means a data network having a short data transmission path as it may local-access a portion of the DN. Further, it may be used to denote a DN where an edge application server supporting an edge computing service is deployed.
PCF receives information about packet flow from application server and provides the function of determining the policy such as mobility management or session management. Specifically, the PCF may support functions such as support of a signalized policy framework for controlling network operations, providing a policy rule to allow CP function(s) (e.g., AMF or SMF) to execute a policy rule, and implementation of a front end for accessing subscription information related to policy decision in the unified data repository (UDR).
SMF provides session management function and, if UE has multiple sessions, this may be managed per session by a different SMF.
The UDM may store, e.g., user's subscription data, policy data.
UPF may transfer downlink PDU received from DN to UE via (R) AN and transfers uplink PDU received from UE to DN via (R) AN. Uplink classifier (ULCL) refers to a UPF having a function of classifying and transmitting uplinks. Local UPF (L-UPF) may serve as a PDU session anchor of a session transmitted to the local part of DN.

When providing an integrated sensing/communication service through a wireless communication system, a method for determining and configuring and applying corresponding service quality is required. A quality control method and device supported in the conventional system providing only communication services is designed for the purpose of guaranteeing traffic transmission/reception quality for a pair of transmission/reception devices or a specific session. In the integrated sensing/communication service, the purpose of quality control on a specific session is not a priority, and communication quality control on the pair of transmission/reception devices is not directly related to sensing service quality. Accordingly, the disclosure proposes a method for enhancing quality control performance for a specific session.

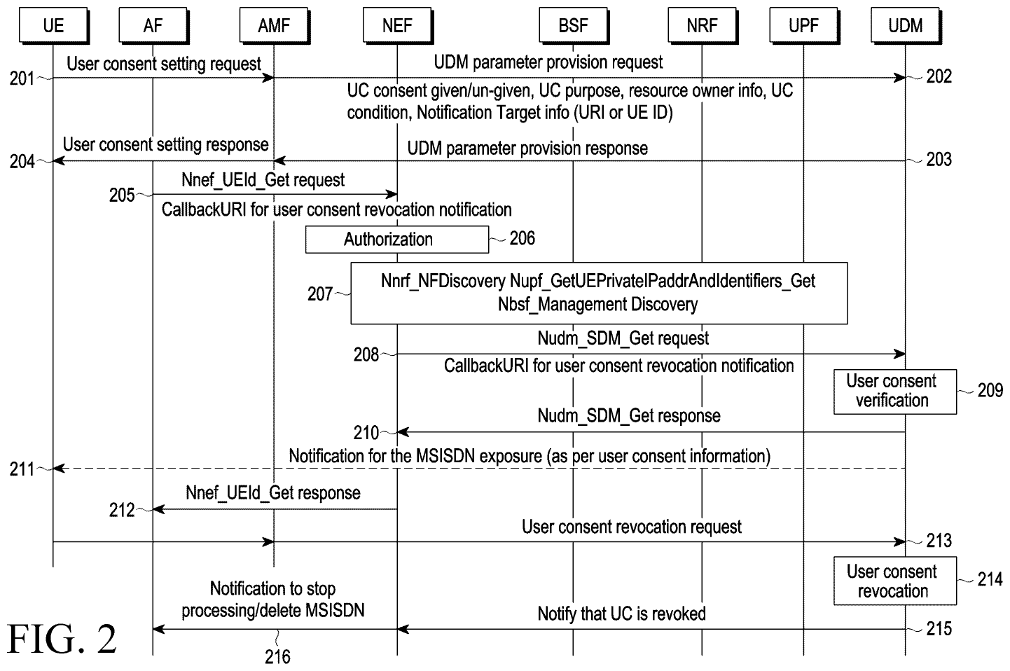

FIG. 2 is a flowchart illustrating operations related to setting and withdrawing user consent when a UE provides user consent given/un-given information according to an embodiment of the disclosure.

In operation 201, the UE may transmit a user consent setting request message to the AMF. The user consent setting request message may include user consent-related information, and the user consent-related information may include at least one of the following information.
resource owner information: owner information of user consent target information. Generally, it may include UE subscriber information, and may include information, such as a subscription permanent identifier (SUPI), a generic public subscription identifier (GPSI), a mobile subscriber integrated services digital network number (MSISDN), and a user identifier (user ID).
user consent given/un-given: information indicating whether the user consents or does not consent
user consent purpose: information indicating at least one of user consent target information or user consent target purpose. For example, if the user consistent purpose is set to MSISDN exposure, it may indicate that the user consents to provide MSISDN to an application server or application function outside the core network.
user consent condition: information indicating user consent conditions. The user consent condition may include at least one of a valid time or valid position information about the user consent. The user consent condition may include an obligation to notify the user of provision information and/or information about the provision target when providing the user's information to the outside. When a notification obligation according to the provision of user information is included in the user consent condition, notification target information may be provided together.

Notification target information (uniform resource identifier (URI), UE identifier, or network address information about the UE): It may include information used to send a notification message to the core network when the user consent-related event occurs to the user. It may include information such as URI or URL, or information such as a UE identifier or an IP address of the UE.

In operation 202, the AMF may transmit user consent-related information included in the user consent setting request message received from the UE to the UDM. For example, if the non-access stratum (NAS) message received from the UE includes user consent setting request information, the AMF may call the UDM parameter provision service provided by the UDM and transmit at least one of the user consent/un-given, user consent purpose, user consent condition, and notification target information included in the user consent-related information received from the UE to the UDM.

In operation 203, the UDM may store the user consent-related information received from the AMF as subscription data, and after successfully storing it, may transmit a response message including information about whether the user consent-related information has been successfully stored in the AMF. For example, the user consent-related information may be stored and managed in the UDM, with at least one of user consent given/un-given, user consent condition, or notification target information corresponding thereto for each user consent purpose. Further, the UDM may transmit the user consent-related information received through AMF to the UDR and store it as subscription data in the UDR.

In operation 204, the AMF may successfully receive information about whether to successfully set user consent-related information from the UDM, and transmit the information to the UE in the user consent setting response as a response message to operation 1.

In operation 205, the AF may transmit a UE ID Get request message to the NEF to request UE-related information (e.g., UE identifier or MSISDN). The UE ID Get request message transmitted to the NEF by the AF may include at least one of the user consent information, CallbackURI for user consent revocation notification, UE identifier type information (MSISDN or external UE ID), GPSI, (i.e. IPv4/IPv6 address or MAC address), External Group Identifier, Data Network Name (DNN), Single Network Slice Selection Assistance Information (S-NSSAI), Port number, Internet Protocol (IP) domain, Application Port ID, MTC provider information, and AF Identifier.

The CallbackURI for user consent revocation notification is a kind of target notification address information, and may indicate address information for receiving a notification of information requested by the AF when the user consent status changes. For example, it may be used for receiving a notification of user consent cancellation/revocation or a change to the non-consented state from the AF and discarding the information not consented by the user. Further, AF may provide user consent information to inform that user consent has been obtained when user consent for the requested information is obtained from the user who is a resource owner. The user consent information provided by the AF may include at least one of an authorization code, an access token, and a client credential.

The NEF may correspondingly store and manage callback URI for user consumer revocation notification information included in the message received from the AF, together with AF ID, application provider information (MTC provider information), DNN, or S-NSSAI. In an embodiment, the NEF may store the corresponding information in the UDR.

In operation 206, the NEF may perform authorization for the request of the AF. Further, the NEF may determine the DNN or S-NSSAI corresponding to the request of the AF.

In operation 207, the NEF may transmit an UPF discovery request to the NRF. In an embodiment, the request message transmitted by the NEF to the NRF may include at least one of UE IP address, DNN, S-NSSAI, and IP domain. The NEF may obtain UPF information from the NRF.

The NEF may send a message requesting the UE's private IP address by calling the Nupf_GetUEPrivateIPaddrAndIdentifiers_Get service from the UPF corresponding to the information obtained from the NRF. In an embodiment, the corresponding request message may include at least one of UE public IP address, Port Number, IP domain, DNN, and S-NSSAI information. In an embodiment, the NEF may obtain a UE private IP address from the UPF. If the UPF has stored SUPI or GPSI information, the NEF may also obtain SUPI or GPSI from the UPF. In an embodiment, if the UE private IP address is obtained from the UPF, the NEF may transmit an Nbsf_Management Discovery message to the BSF to request a UE identifier while providing at least one of the UE private IP address, DNN, and S-NSSAI. In an embodiment, the NEF may obtain the UE identifier SUPI from the BSF.

In operation 208, the NEF may transmit, to the UDM, a UE identifier request message (e.g., a Nudm_SDM_SDM_Get service call message) including at least one of the UE identifier (SUPI), the request UE identifier type (MSISDN, external UE ID), DNN, S-NSSAI, Application Port ID, MTC provider information, or AF identifier obtained in operation 207. In an embodiment, the NEF may provide user consent information and CallbackURI for user consent revocation notification received from the AF in operation 205 to the UDM.

In operation 209, the UDM may perform the user consent verification operation for identifying whether there is consent from the user who is the resource owner to the AF request information received from the NEF. To this end, the UDM may identify at least one of the user consent given/ungiven, or user consent purpose, user consent condition included in the subscription data stored in the UDM or UDR.

For example, the UDM may determine to provide MSISDN information for the request UE identifier received from the NEF. In this case, the UDM may identify at least one of the user consent given, user consent purpose (whether the user consent target information represents MSISDN), and user consent condition (e.g., whether the user should be notified when providing MSISDN information) for providing MSISDN information.

In operation 210, when it is identified in operation 209 that there is user consent to the UE identifier (e.g., MSISDN) requested by the AF, the UDM may transmit a response message including the corresponding information to the NEF. For example, the UDM may provide at least one of information, such as MSISDN information or MSISDN information destruction deadline, to the NEF. The UDM may store and manage the corresponding record when providing user consent target information. To this end, the information stored and managed by the UDM may include what information is provided (e.g., MSISDN in this embodiment), where the information is provided (AF ID, application provider information, or NEF), callback URI for user consumer revocation notification, or information about the timing of provision. In an embodiment, the UDM may additionally store the record in the UDR.

In operation 211, the UDM may transmit a MSISDN exposure-related notification message to the corresponding UE if the user condition information about the information provided to the AF through the NEF includes a resource owner user notification. To this end, the UDM may select the AMF where the UE has performed the registration procedure and transmit a Notification for the MSISDN exposure message to be transmitted to the UE. The message may include at least one of MSISDN exposure and a provision target (AF information). The MSISDN exposure-related notification message may be provided to the UE through an AMF. To this end, the AMF may perform paging and service request procedures to transmit signaling including a Notification for the MSISDN exposure message to the UE. In an embodiment, the notification transmission according to the user component condition performed in operation 211 may be performed after operation 212 (the step of providing the corresponding information to the AF).

In operation 212, the NEF may transmit a response message to operation 5 to the AF. The message may include at least one of MSISDN information and an MSISDN information destruction deadline.

In operation 213, the UE of the resource owner user may perform the user consent withdrawal request. The timing of performing the operation is not limited. The user consent revocation request message for the UE's user consent withdrawal request may be transmitted to the AMF through the transmission of the user consent setting request as illustrated in operations 201 to 202, and may be transmitted from the AMF to the UDM. In an embodiment, the corresponding message transmitted by the UE may include at least one of user context un-given or user context purpose information. The message refers to changing the user consent status by disagreeing with the external leakage of information corresponding to the user consent purpose. For example, when MSISDN is user consent target information, the user consent purpose may represent MSISDN exposure.

In operation 214, when the UDM receives a message including at least one of user consent purpose or user consent un-given from the AMF through operation 13, it may set that the user consent has been withdrawn by updating user consent-related information stored in the UDM. For example, by updating the subscription data information stored in UDM and UDR, the user consent status corresponding to the user consumer purpose may be set to user consumer un-given. Further, the UDM may perform a user consent revocation notification operation when identifying that there is a record that information matching the user consent purpose has been provided to the outside (identifying the record stored in the UDM or UDR).

In operation 215, the UDM may transmit the user consumer revocation notification message to the AF that has provided the MSISDN through the NEF. The user consent notification message may include an indicator or information indicating that the corresponding user consent has been withdrawn. In this case, if the UDM knows the information about the callback URI for user consent revocation notification, the UDM may include the callback URI for user consent revocation notification in the user consent revocation notification message and transmit it to the NEF.

Operation 216 NEF may use callback URI for user consent revocation notification to transmit the user consent revocation notification message received from the UDM to the notification target AF. In an embodiment, the callback URI for user consent revocation notification may use information received from UDM or callback URI for user revocation notification information stored and managed by the NEF. In an embodiment, the NEF may obtain and transmit the callback URI for user consent revocation notification from the UDR to transmit the user consent revocation notification message to the AF. The AF receiving the user consent revocation notification message may destroy information (e.g., MSISDN) obtained through the NEF.

The AF may provide the callback URI for user consent revocation notification information provided in operation 205 as a notification target address to receive the user consent revocation notification message. The AF may include the callback URI for user consent revocation notification information in the subscription request message and transmit the same to the NEF. For example, the NEF and UDM may provide separate notification services to notify of information about user consent status, such as user consent given/un-given or user consent granted/revocation, and the AF or network function in the core network may transmit a subscription request for the event (user consent status change event or user consent status monitoring event) to the NEF or UDM to be notified of user consent/status information.

In this case, the notification target address information included when sending a subscription request to the NEF or UDM may include callback URI for user consent revocation notification information. Further, the UE may directly transmit an information notification request indicator about the user consent status to the NEF or UDM in order to obtain user consent/status information. The UE may transmit the user consent/status information request indicator to the UDM through the AMF or to the UDM through the NEF. The corresponding operation may be performed not as the user consent setting request operation, but as an operation for receiving current or future user consent or status information stored in the core network.

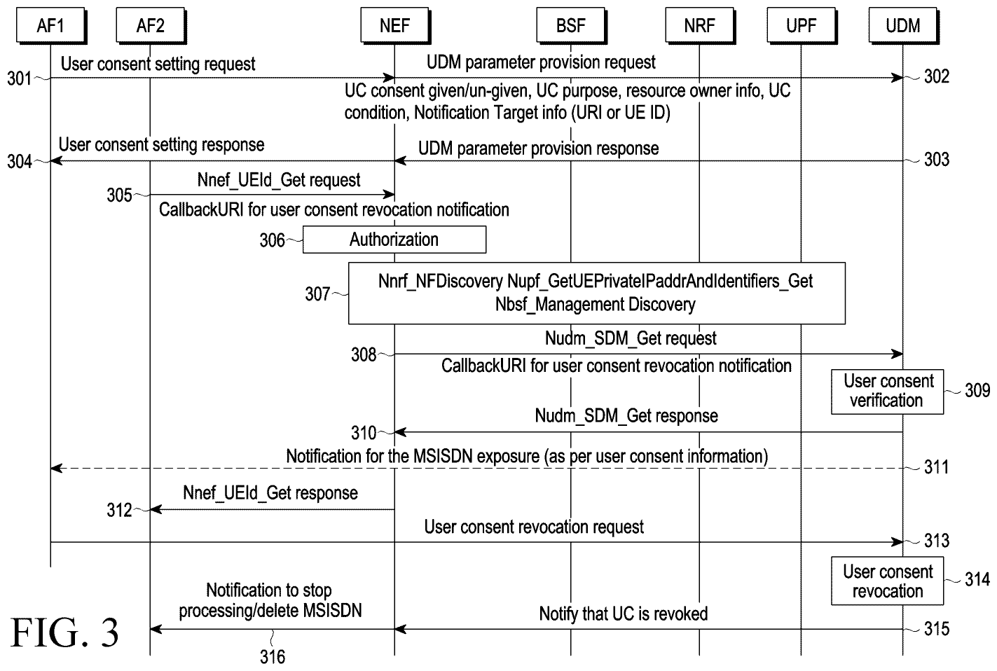

FIG. 3 is a flowchart illustrating operations related to setting and withdrawing user consent when an AF provides user consent given/un-given information according to an embodiment of the disclosure.

In this embodiment, AF 1 is a device that provides user consent given/un-given information to the core network on behalf of the user (or the user's UE) who is the resource owner. AF 2 is a device that requests and obtains information requiring user consent (e.g., the MSISDN) from the core network, and may be considered a device that is hosted and operated by a provider that is generally different from the provider of AF 1.

In operation 301, AF 1 may transmit a user consent setting request message to the NEF. The user consent setting request message may include user consent-related information, and the user consent-related information may include at least one of the following information.
resource owner information: the owner of the user consent target information, which may generally mean the user or UE subscriber. This may include information such as the SUPI, GPSI, MSISDN, or user ID.
user consent given/un-given: information indicating whether the user consents or does not consent
user consent purpose: information indicating at least one of user consent target information or user consent target purpose. For example, if the user consistent purpose is set to MSISDN exposure, it may indicate that the user consents to provide MSISDN to an application server or application function outside the core network.
user consent condition: information indicating user consent conditions. The user consent condition may include at least one of a valid time or valid position information about the user consent. The user consent condition may include an obligation to notify the user of provision information and/or information about the provision target when providing the user's information to the outside. When a notification obligation according to the provision of user information is included in the user consent condition, notification target information may be provided together.

Notification target information (URI, UE identifier, or network address information about the UE): It may include information used to send a notification message to the core network when the user consent-related event occurs to the user. It may include information such as URI or URL, or information such as a UE identifier or an IP address of the UE.

In operation 302, the NEF may transmit user consent-related information included in the user consent setting request message received from AF 1. For example, if the message received from AF 1 includes user consent setting request information, the NEF may call the UDM parameter provision service provided by the UDM and transmit the user consent/un-given, user consent purpose, user consent condition, and notification target information received from AF 1 to the UDM. In this case, the notification target information may include URI information about AF 1 or address information about the NEF (e.g., URI, notification target address of NEF). In an embodiment, AF 1 may provide the NEF with information about the UE of the user (the user as the resource owner) that is managed by the AF 1 and transmitted on behalf of user consent setting request information. In an embodiment, the UE information about the user who is the corresponding resource owner may be provided to the NEF as a portion of notification target information. In an embodiment, the core network (UDM or NEF) may use the UE information about the user who is the resource owner to transmit the user consent-related notification to the UE of the user who is the resource owner of the user consent target information.

In operation 303, the UDM may store the user consent-related information received from the NEF as subscription data, and after successfully storing it, may transmit a response message including information about whether the user consent-related information has been successfully stored in the NEF. For example, the user consent-related information may be stored and managed in the UDM, with at least one of user consent given/un-given, user consent condition, or notification target information corresponding thereto for each user consent purpose. Further, the UDM may transmit the user consent-related information received through NEF to the UDR and store it as subscription data in the UDR.

In operation 304, the NEF may successfully receive information about whether to successfully set user consent-related information from the UDM, and transmit the information to AF 1 in the user consent setting response as a response message to operation 301.

In operation 305, AF 2 may transmit a UE Identifier (ID) Get request message to the NEF to request UE-related information (e.g., UE identifier or MSISDN). The UE ID Get request message transmitted to the NEF by AF 2 may include at least one of the user consent information, CallbackURI for user consent revocation notification, UE identifier type information (MSISDN or external UE ID), GPSI, (i.e. IPv4/IPv6 address or MAC address), External Group Identifier, DNN, S-NSSAI, Port number, IP domain, Application Port ID, MTC provider information, and AF Identifier.

The CallbackURI for user consent revocation notification is a kind of target notification address information, and may indicate address information for receiving a notification of information requested by AF 2 when the user consent status changes. For example, it may be used for receiving a notification of user consent cancellation/revocation or a change to the non-consented state from AF 2 and discarding the information not consented by the user. Further, AF 2 may provide user consent information to inform that user consent has been obtained when user consent to the requested information is obtained from the user who is the resource owner or AF 1 (e.g., when AF 2 has obtained user consent to the use and acquisition of specific information from the user who is the resource owner or AF 1 through signaling at the other application layer or open authentication 2.0). The user consent information provided by AF 2 may include at least one of an authorization method, authorization server information, an authorization code, an access token, or a client credential. In an embodiment, when the NEF receives user consent information from AF 2, it may perform interworking with the authorization server or the UE of the user who is the resource owner, to determine whether the user consent information is authentic or not. Alternatively, the NEF may identify that the user consent information stored in the UDM (user consent given status and user consent purpose) and the user consent information provided by AF 2 match.

The NEF may correspondingly store and manage callback URI for user consumer revocation notification information included in the message received from AF 2, together with AF ID, application provider information (MTC provider information), DNN, or S-NSSAI. In an embodiment, the NEF may store the corresponding information in the UDR.

In operation 306, the NEF may perform authorization for the request of AF 2. Further, the NEF may determine the DNN or S-NSSAI corresponding to the request of AF 2.

In operation 307, the NEF may transmit an UPF discovery request to the NRF. In an embodiment, the request message transmitted by the NEF to the NRF may include at least one of UE IP address, DNN, S-NSSAI, and IP domain. The NEF may obtain UPF information from the NRF.

The NEF may send a message requesting the UE's private IP address by calling the Nupf_GetUEPrivateIPaddrAndIdentifiers_Get service from the UPF corresponding to the information obtained from the NRF. In an embodiment, the corresponding request message may include at least one of UE public IP address, Port Number, IP domain, DNN, and S-NSSAI information. The NEF may obtain a UE private IP address from the UPF. If the UPF has stored SUPI or GPSI information, the NEF may also obtain SUPI or GPSI from the UPF. In an embodiment, if the UE private IP address is obtained from the UPF, the NEF may transmit an Nbsf_Management Discovery message to the BSF to request a UE identifier while providing at least one of the UE private IP address, DNN, and S-NSSAI. In an embodiment, the NEF may obtain the UE identifier SUPI from the BSF.

In operation 308, the NEF may transmit, to the UDM, a UE identifier request message (e.g., a Nudm_SDM_SDM_Get service call message) including at least one of the UE identifier (SUPI), the request UE identifier type (MSISDN, external UE ID), DNN, S-NSSAI, Application Port ID, MTC provider information, or AF identifier obtained in operation 307. In an embodiment, the NEF may provide user consent information (e.g., authorization code) and CallbackURI for user consent revocation notification received from AF 2 in operation 5 to the UDM.

In operation 309, the UDM may perform the user consent verification operation for identifying whether there is consent from the user who is the resource owner to the AF 2 request information received from the NEF. To this end, the UDM may identify at least one of the user consent given/ungiven, or user consent purpose, user consent condition included in the subscription data stored in the UDM or UDR.

For example, the UDM may determine to provide MSISDN information for the request UE identifier received from the NEF. In this case, the UDM may identify at least one of the user consent given, user consent purpose (whether the user consent target information represents MSISDN), and user consent condition (e.g., whether the user should be notified when providing MSISDN information) for providing MSISDN information.

In operation 310, when it is identified in operation 309 that there is user consent to the UE identifier (e.g., MSISDN) requested by the AF 2, the UDM may transmit a response message including the corresponding information to the NEF. For example, the UDM may provide at least one of information, such as MSISDN information or MSISDN information destruction deadline, to the NEF. The UDM may store and manage the corresponding record when providing user consent target information. To this end, the information stored and managed by the UDM may include what information is provided (e.g., MSISDN in this embodiment), where the information is provided (AF ID, application provider information, or NEF), callback URI for user consumer revocation notification, or information about the timing of provision. In an embodiment, the UDM may additionally store the record in the UDR.

In operation 311, the UDM may transmit an MSISDN exposure-related notification message to AF 1 that provides and manages user consent given/un-given information instead of the resource owner if the user consent condition information about the information provided to AF 2 through NEF includes resource owner user notification. To this end, the UDM may use notification target information (at least one of URI information about AF 1 or address information about NEF), which is the information received in operation 302. The message may include MSISDN exposure and provision targets (AF2 information, AF2 identifier, AF2 provider information, etc.).

In an embodiment, according to user consent condition information and/or user consent resource owner information, an MSISDN exposure-related notification message may be transmitted to the corresponding UE (the UE of the resource owner user). To this end, the UDM may select the AMF where the UE has performed the registration procedure and transmit, to the corresponding AMF, a Notification for the MSISDN exposure message to be transmitted to the UE. The message may include MSISDN exposure and provision targets (AF2 information, AF2 identifier, AF2 provider information, etc.). The MSISDN exposure-related notification message may be provided to the UE through an AMF. To this end, the AMF may perform paging and service request procedures to transmit signaling including a Notification for the MSISDN exposure message to the UE. The notification transmission according to the user component condition performed in operation 311 may be performed after operation 312 (the step of providing the corresponding information to AF 2). In an embodiment, the above-described MSISDN exposure information-related notification message may be transmitted from the UDM to both AF1 and the UE of the user who is the resource owner.

In operation 312, the NEF may transmit a response message to operation 305 to AF 2. The message may include at least one of MSISDN information and an MSISDN information destruction deadline.

In operation 313, AF 1 may perform the user consent withdrawal request. The timing of performing the operation is not limited. The user consent revocation request message for AF 1's user consent withdrawal request may be transmitted to the NEF through the transmission of the user consent setting request as illustrated in operations 301 to 302, and may be transmitted from the NEF to the UDM. The corresponding message transmitted by AF 1 may include at least one of user context un-given or user context purpose information. The message refers to changing the user consent status by disagreeing with the external leakage of information corresponding to the user consent purpose. For example, when MSISDN is user consent target information, the user consent purpose may represent MSISDN exposure.

In operation 314, when the UDM receives a message including at least one of user consent purpose or user consent un-given from AF 1 (through the NEF) through operation 313, it may set that the user consent has been withdrawn by updating user consent-related information stored in the UDM. For example, by updating the subscription data information stored in UDM and UDR, the user consent status corresponding to the user consumer purpose may be set to user consumer un-given. Further, the UDM may perform a user consent revocation notification operation when identifying that there is a record that information matching the user consent purpose has been provided to the outside (identifying the record stored in the UDM or UDR).

In operation 315, the UDM may transmit the user consumer revocation notification message to AF 2 that has provided the MSISDN through the NEF. The user consent notification message may include an indicator or information indicating that the corresponding user consent has been withdrawn. In this case, if the UDM knows the information about the callback URI for user consent revocation notification, the UDM may include the callback URI for user consent revocation notification in the user consent revocation notification message and transmit it to the NEF.

In operation 316, the NEF may use callback URI for user consent revocation notification to transmit the user consent revocation notification message received from the UDM to the notification target AF 2. In an embodiment, the callback URI for user consent revocation notification may use information received from UDM or callback URI for user revocation notification information stored and managed by the NEF. In an embodiment, the NEF may obtain and transmit the callback URI for user consent revocation notification from the UDR to transmit the user consent revocation notification message to AF 2. AF 2 receiving the user consent revocation notification message may destroy information (e.g., MSISDN) obtained through the NEF.

AF 2 may provide the callback URI for user consent revocation notification information provided in operation 305 as a notification target address to receive the user consent revocation notification message. AF 2 may include the callback URI for user consent revocation notification information in the subscription request message and transmit the same to the NEF. For example, the NEF and UDM may provide separate notification services to notify of information about user consent status, such as user consent given/un-given or user consent granted/revocation, and the AF or network function in the core network may transmit a subscription request for the event (user consent status change event or user consent status monitoring event) to the NEF or UDM to be notified of user consent/status information.

In this case, the notification target address information included when sending a subscription request to the NEF or UDM may include callback URI for user consent revocation notification information. Further, the UE may directly transmit an information notification request indicator about the user consent status to the NEF or UDM in order to obtain user consent/status information. The UE may transmit the user consent/status information request indicator to the UDM through the AMF or to the UDM through the NEF. The corresponding operation may be performed not as the user consent setting request operation, but as an operation for receiving current or future user consent or status information stored in the core network.

According to an embodiment of the disclosure, the UDM may receive user consent information (user consent given/un-given, user consent purpose, user consent condition, notification target information, and resource owner information) by receiving the user consent setting request message through the UE of the user who is the resource owner or the AF (resource owner agent or resource owner client) serving as an agent for the resource owner.

In an embodiment, UDM may set the user consent purpose differently for each type of specific information related to the user and manage the user consent, and obtain and manage user consent given/un-given for each user consent purpose from the UE or the AF. For example, the UE or AF may provide user consent information set to MSISDN exposure and user consent information set to user consent given to the UDM through AMF or NEF, and the UDM may manage the corresponding user consent purpose and user consent given with them corresponding thereto.

In an embodiment, if the user consent is withdrawn after providing the information consented by the user to the external AF, the UDM or the NEF may obtain, store, or manage the information for performing the operation for notifying the external AF that user consent has been withdrawn, from the external AF. The information for performing the operation for notifying the external AF that the user consent has been withdrawn may include at least one of callback URI for user consent notification information, AF identifier, AF transaction ID, AF notification correlation ID, or AF subscription ID information. In an embodiment, the UDM and NEF may store the information in the UDR and obtain and use the information from the UDR if necessary.

According to an embodiment of the disclosure, the user equipment (UE) may transmit a user consent setting request message to the UDM through the AMF. The user consent setting request message may include user consent-related information. The user consent-related information may include at least one of resource owner information of user consent target information, user consent given/un-given information, user consent purpose information, user consent condition information, and user consent-related event notification target information.

In an embodiment, the UE may receive a response message to the user consent setting from the UDM through the AMF.

In an embodiment, the UE may transmit a user consent withdrawal request message. The timing of performing the operation is not limited. The user consent revocation request message for the UE's user consent withdrawal request may be transmitted to the AMF, and may be transmitted from the AMF to the UDM. In an embodiment, the corresponding message transmitted by the UE may include at least one of user context un-given or user context purpose information. The message refers to changing the user consent status by disagreeing with the external leakage of information corresponding to the user consent purpose. For example, when MSISDN is user consent target information, the user consent purpose may represent MSISDN exposure.

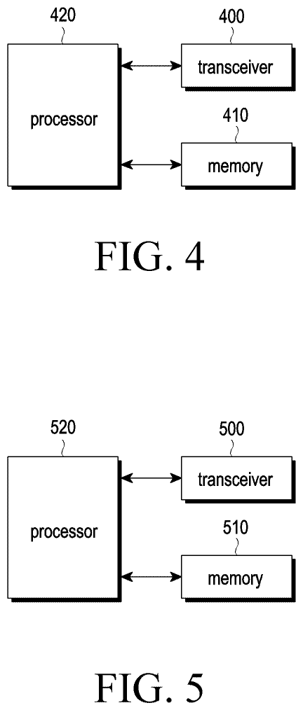

FIG. 4 is a block diagram illustrating a configuration of a network entity according to an embodiment of the disclosure.

According to an embodiment of the disclosure, the network entity may include a processor 420 controlling the overall operation of the network entity, a transceiver 400 including a transmitter and a receiver, and memory 410. Without limited thereto, the network entity may include more or less components than those shown in FIG. 4.

According to an embodiment of the disclosure, the transceiver 400 may transmit/receive signals to/from at least one of other network entities or a UE. The signals transmitted/received with at least one of the other network entities or the UE may include control information and data.

According to an embodiment of the disclosure, the processor 420 may control the network entity to perform any one of the above-described embodiments. The processor 420, the memory 410, and the transceiver 400 are not necessarily implemented in separate modules but rather as a single component, e.g., a single chip. The processor 420 and the transceiver 400 may be electrically connected with each other. The processor 420 may be an application processor (AP), a communication processor (CP), a circuit, an application-specific circuit, or at least one processor.

According to an embodiment of the disclosure, the memory 410 may store a default program for operating the network entity, application programs, and data, such as configuration information. The memory 410 provides the stored data according to a request of the processor 420. The memory 410 may include a storage medium, such as Read-Only Memory (ROM), Random Access Memory (RAM), hard disk, Compact Disc-ROM (CD-ROM), and Digital Versatile Disc (DVD), or a combination of storage media. There may be provided a plurality of memories 410. The processor 420 may perform the above-described embodiments based on a program for performing the above-described embodiments stored in the memory 410. The processor 420 may include at least one processor.

When the network entity illustrated in FIG. 4 is referred to as a first network entity, the at least one processor may control to receive a user consent setting request message including user consent-related information. The at least one processor may control to receive the UE-related information request message from the first application function (AF) entity. The at least one processor may transmit UE-related information to the first AF entity based on the user consent-related information. In an embodiment, the user consent setting request message may be received from a UE or a second AF entity.

The at least one processor may control to receive target information of the user consent withdrawal notification from the second network entity. The at least one processor may receive a user consent withdrawal request from a UE or a second AF entity. The at least one processor may transmit the user consent withdrawal notification based on target information of the user consent withdrawal notification.

In an embodiment, the user consent-related information may include at least one of resource owner information of user consent target information, user consent given/un-given information, user consent purpose information, user consent condition information, and user consent-related event notification target information.

When the user consent-related information includes user consent-related event notification target information, the at least one processor may notify that UE-related information has been provided to the first AF entity based on the user consent-related event notification target information. The UE-related information may include a mobile subscriber integrated services digital network number (MSISDN).

FIG. 5 is a block diagram illustrating a configuration of a UE according to an embodiment of the disclosure.

Referring to FIG. 5, a UE may include a processor 520, a transceiver 500, and memory 510. The processor 520, transceiver 500, and memory 510 of the UE of FIG. 7 may be operated according to the method(s) described above. However, the components of the UE are not limited thereto. For example, the UE may include more or fewer components than the above-described components. The processor 520, the transceiver 500, and the memory 510 may be implemented in the form of at least one chip.

The transceiver 500 collectively refers to a receiver and a transmitter and may transmit and receive signals to/from a UE or another network entity. The transmitted/received signals may include at least one of control information and data. To that end, the transceiver 500 may include an RF transmitter for frequency-up converting and amplifying signals transmitted and an RF receiver for low-noise amplifying signals received and frequency-down converting the frequency of the received signals. This is merely an embodiment of the transceiver 500, and the components of the transceiver 500 are not limited to the RF transmitter and the RF receiver. Further, the transceiver 500 may receive signals through a communication scheme defined in the 3GPP standard, output the signals to the processor 520, and transmit the signals output from the processor 520. Further, the transceiver 500 may receive the signal and output it to the processor 520 and transmit the signal output from the processor 520 to another network entity through the network.

The memory 510 may store programs and data necessary for the operation of the UE according to at least one of the above-described embodiments. The memory 510 may store control information and/or data that is included in the signal obtained by the UE. The memory 510 may include a storage medium, such as ROM, RAM, hard disk, CD-ROM, and DVD, or a combination of storage media.

The processor 520 may control a series of processes for the UE to be able to operate according to at least one of the above-described embodiments. The processor 2101 may include at least one processor.

The at least one processor may control to transmit, to a first network entity, a user consent setting request message including user consent-related information. The at least one processor may control to receive a user consent setting response message from the first network entity. The user consent-related information may be used to provide UE-related information to a first AF entity having transmitted a UE-related information request message.

The at least one processor may control to transmit a user consent withdrawal request to the second network entity. In an embodiment, the user consent-related information may include at least one of resource owner information of user consent target information, user consent given/un-given information, user consent purpose information, user consent condition information, and user consent-related event notification target information.

When the user consent-related information includes user consent-related event notification target information, the at least one processor may control to receive a notification of having provided UE-related information to the first AF entity based on the user consent-related event notification target information from the first network entity.

It should be noted that the above-described configuration views, example views of control/data signal transmission methods, example views of operational procedures, and configuration views are not intended as limiting the scope of the disclosure. In other words, all the components, entities, or operational steps described in connection with the embodiments should not be construed as essential components to practice the disclosure, and the disclosure may be rather implemented with only some of the components without departing from the gist of the disclosure. The embodiments may be practiced in combination, as necessary. For example, some of the methods proposed herein may be combined to operate the network entity and the UE.

The above-described operations of the base station or UE may be realized by equipping memory device retaining their corresponding codes in the base station device or any component of the UE. That is, the controller in the eNB or terminal may execute the above-described operations by reading and executing the program codes stored in the memory device by a processor or central processing unit (CPU).

As described herein, various components or modules in the entity, base station or UE may be operated using a hardware circuit, e.g., a complementary metal oxide semiconductor-based logic circuit, firmware, software, and/or using a hardware circuit such as a combination of hardware, firmware, and/or software embedded in a machine-readable medium. As an example, various electric structures and methods may be executed using electric circuits such as transistors, logic gates, or application-specific integrated circuits (ASICs).

When implemented in software, there may be provided a computer readable storage medium storing one or more programs (software modules). One or more programs stored in the computer readable storage medium are configured to be executed by one or more processors in an electronic device. One or more programs include instructions that enable the electronic device to execute methods according to the embodiments described in the specification or claims of the disclosure.

The programs (software modules or software) may be stored in random access memories, non-volatile memories including flash memories, read-only memories (ROMs), electrically erasable programmable read-only memories (EEPROMs), magnetic disc storage devices, compact-disc ROMs, digital versatile discs (DVDs), or other types of optical storage devices, or magnetic cassettes. Or, the programs may be stored in memory constituted of a combination of all or some thereof. As each constituting memory, multiple ones may be included.

The programs may be stored in attachable storage devices that may be accessed via a communication network, such as the Internet, Intranet, local area network (LAN), wide area network (WLAN), or storage area network (SAN) or a communication network configured of a combination thereof. The storage device may connect to the device that performs embodiments of the disclosure via an external port. A separate storage device over the communication network may be connected to the device that performs embodiments of the disclosure.

In the above-described specific embodiments, the components included in the disclosure are represented in singular or plural forms depending on specific embodiments proposed. However, the singular or plural forms are selected to be adequate for contexts suggested for ease of description, and the disclosure is not limited to singular or plural components. As used herein, the singular forms “a,” “an,” and “the” are intended to include the plural forms as well, unless the context clearly indicates otherwise.

Although specific embodiments of the disclosure have been described above, various changes may be made thereto without departing from the scope of the disclosure. Thus, the scope of the disclosure should not be limited to the above-described embodiments, and should rather be defined by the following claims and equivalents thereof. In other words, it is apparent to one of ordinary skill in the art that various changes may be made thereto without departing from the scope of the disclosure. Further, the embodiments may be practiced in combination. For example, some of the methods proposed herein may be combined to operate the base station and the UE. Although the embodiments are proposed in association with 5G and NR systems, various modifications thereto may apply to other various systems, such as Long Term Evolution (LTE), LTE-Advanced (LTE-A), LTE-A-Pro systems.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a unified data management (UDM) in a wireless communication system, the method comprising:
receiving, from a network exposure function (NEF), a user equipment (UE) identifier (ID) request related to a first application function (AF);
identifying user consent for the UE ID request; and
transmitting, to the first AF through the NEF, a UE ID based on the user consent.

2. The method of claim 1, wherein the UE ID includes a mobile subscriber integrated services digital network number (MSISDN).

3. The method of claim 1, wherein the UE ID request includes at least one of: SUPI (subscription permanent identifier), at least one application port ID, MTC (machine type communication) provider information or AF identifier of the first AF.

4. The method of claim 1, further comprising:
receiving, from a UE or a second AF, a user consent setting request message including user consent-related information.

5. The method of claim 1, further comprising:
receiving, from the NEF, user consent withdrawal notification target information;
receiving, from a UE or a second AF, a user consent withdrawal request; and
transmitting a user consent withdrawal notification based on the user consent withdrawal notification target information.

6. The method of claim 4, wherein the user consent-related information includes at least one of resource owner information on user consent target information, user consent given/un-given information, user consent purpose information, user consent condition information, or user consent-related event notification target information.

7. The method of claim 4, further comprising,
in case that the user consent-related information includes user consent-related event notification target information, notifying that UE-related information has been provided to the first AF based on the user consent-related event notification target information.

8. A method performed by a user equipment (UE) in a wireless communication system, the method comprising:
transmitting, to a unified data management (UDM), a user consent setting request message including user consent-related information; and
receiving, from the UDM, a user consent setting response message,
wherein the user consent-related information is used to provide a UE identifier (ID) to a first application function (AF) having transmitted a UE ID request.

9. The method of claim 8, further comprising:
transmitting, to the UDM, a user consent withdrawal request.

10. The method of claim 8, wherein the user consent-related information includes at least one of resource owner information on user consent target information, user consent given/un-given information, user consent purpose information, user consent condition information, or user consent-related event notification target information.

11. The method of claim 8, further comprising, in case that the user consent-related information includes user consent-related event notification target information, receiving, from the UDM, a notification of having provided UE-related information to the first AF based on the user consent-related event notification target information.

12. A unified data management (UDM) entity in a wireless communication system, the UDM entity comprising:
a transceiver; and
at least one processor communicatively coupled to the transceiver; and
memory, communicatively coupled to the at least one processor, storing instructions executable by the at least one processor individually or in any combination to cause the UDM entity to:
receive, from a network exposure function (NEF), a user equipment (UE) identifier (ID) request related to a first application function (AF),
identify user consent for the UE ID request, and
transmit, to the first AF through the NEF, a UE ID based on the user consent.

13. The UDM entity of claim 12, wherein the UE ID includes a mobile subscriber integrated services digital network number (MSISDN).

14. The UDM entity of claim 12, wherein the UE ID request includes at least one of: SUPI (subscription permanent identifier), at least one application port ID, MTC (machine type communication) provider information or AF identifier of the first AF.

15. The UDM entity of claim 12, wherein the instructions, when executed by the one or more processors individually or collectively, cause the UDM entity to:
receive, from a UE or a second AF, a user consent setting request message including user consent-related information.

16. The UDM entity of claim 12, wherein the instructions, when executed by the one or more processors individually or collectively, cause the UDM entity to:
receive, from the NEF, user consent withdrawal notification target information;
receive, from a UE or a second AF, a user consent withdrawal request; and
transmit a user consent withdrawal notification based on the user consent withdrawal notification target information.

17. The UDM entity of claim 15, wherein the user consent-related information includes at least one of resource owner information on user consent target information, user consent given/un-given information, user consent purpose information, user consent condition information, or user consent-related event notification target information.

18. The UDM entity of claim 15, wherein the instructions, when executed by the one or more processors individually or collectively, cause the UDM entity to:
in case that the user consent-related information includes user consent-related event notification target information, notify that UE-related information has been provided to the first AF based on the user consent-related event notification target information.

19. A user equipment (UE) in a wireless communication system, the UE comprising:
a transceiver; and
at least one processor communicatively coupled to the transceiver and
memory, communicatively coupled to the at least one processor, storing instructions executable by the at least one processor individually or in any combination to cause the UE to:
transmit, to a unified data management (UDM), a user consent setting request message including user consent-related information, and
receive, from the UDM, a user consent setting response message,
wherein the user consent-related information is used to provide UE identifier (ID) to a first application function (AP) having transmitted a UE ID request.

20. The UE of claim 19, wherein the instructions, when executed by the one or more processors individually or collectively, cause the UE to:
transmit, to the UDM, a user consent withdrawal request.
